(19) United States
(12) Patent Application Publication
(10) Pub. No.: US 2015/0230882 A1
(43) Pub. Date: Aug. 20, 2015

(54) Dental Curing Light Sleeve

(71) Applicant: TIDI Products, LLC, Neenah, WI (US)

(72) Inventor: Kurt Miller, Neenah, WI (US)

(73) Assignee: TIDI Products, LLC, Neenah, WI (US)

(21) Appl. No.: 14/279,116

(22) Filed: May 15, 2014

Related U.S. Application Data
(63) Continuation-in-part of application No. 29/482,554, filed on Feb. 19, 2014, now Pat. No. D731652.

(51) Int. Cl. A61C 1/16; A61C 1/08; A61C 13/15

(52) U.S. Cl. CPC A61C 1/16; A61C 19/003; A61C 1/088

(57) ABSTRACT

A dental curing light sleeve with a closed distal end, an open proximal end, and an elongated tubular structure with at least three different sections of varying circumferences is disclosed. The sleeve may be created by heat sealing at least two sheets of an impermeable polymeric material. Three sheets of impermeable polymeric material may be used to create the sleeve, with the two outer sheets being substantially the same length and dimensions and the third sheet of a shorter length placed between the two outer sheets. This provides the sleeve with added strength along the majority of the sleeve while still having minimal obstruction of the curing light, which may occur when additional sheets of material are included. Additionally, the sleeve may have a ring section located at the open proximal end, which allows a user to grip the sleeve and apply it to the dental curing light.

### CROSS-REFERENCE(S) TO RELATED APPLICATION(S)

This application is a continuation in part and claims the benefit of priority of U.S. Design patent application Ser. No. 29/482,554 filed Feb. 19, 2014, the entire contents of which are hereby expressly incorporated by reference into the present application.

### BACKGROUND OF THE INVENTION

1. Field of the Invention

The present invention relates in general to the field of sleeves, barriers, sheaths, and covers. More particularly, the present invention relates to a sleeve for use with medical equipment, specifically dental curing lights, that reduces contamination when the medical equipment is subsequently reused.

2. Discussion of the Related Art

Various types of sleeves, barriers, sheaths, or other covers are frequently used with a variety of medical equipment that come in close contact with a patient's body, for instance, dental curing lights and endoscopes. Especially in instances where the medical equipment enters the patient's body, the medical equipment must be disinfected before it can be reused to avoid spread of germs and disease. Disinfection can be expensive and time consuming, and thus use of a sleeve that can easily be thrown away after use is appealing. As these sleeves are disposable, they must be affordably manufactured. However, while the sleeve must be affordable, it must be durable so that it does not rip or tear when applied to the medical equipment. Obviously, a tight-fitting sleeve is preferred as this will minimize the impact of the sleeve on the doctor or dentist's ability to efficiently perform the procedure. This is especially true where the sleeve is used with a curing light or endoscope because a tight fitting sleeve will reduce the risk of obstruction of the transmitted light or camera. What is desired, therefore, is a sleeve that is made of inexpensive material and that forms a tight-fitting relationship with the medical equipment to which it is affixed to reduce the spread of infectious diseases.

### SUMMARY AND OBJECTS OF THE INVENTION

By way of summary, the present invention is directed to a single use sleeve. A primary object of the invention is to form the single use sleeve by heat sealing at least two sheets of an impermeable polymeric material, such as polyethylene. As a result, the sleeve has an elongated tubular structure, a closed distal end, and an open proximal end. The sleeve also has an inner surface that substantially surrounds a volume adapted for placement over a dental curing light. This configuration reduces cross-contamination and the spread of diseases which may be transmitted by or through contact with human body fluids and tissues during a first and subsequent use of the dental curing light that may occur with treatment of two or more patients. In turn, this will allow a user to avoid the need for repeated disinfection of the dental curing light between patients. The elongate tubular sleeve has at least four sections of varying circumferences and at least one closed end. The first section has a beginning circumference of approximately 4.0 inches (10.16 cm) and tapering to a circumference of approximately 2.75 inches (6.985 cm). The second section begins at the end of the first section and thus has a starting circumference of approximately 2.75 inches (6.985 cm), and tapers to a circumference of approximately 1.88 inches (4.775 cm). The third section begins at the end of the second section and thus has a starting circumference of approximately 1.88 inches (4.775 cm) and tapers to a circumference of approximately 1.814 inches (4.608 cm). The end of the third section is connected to closed distal end, which is rounded. The fourth section extends from the first section opposite the second section and has a constant circumference of 4.0 inches (10.16 cm). The sleeve is made of a material with sufficient elastic material memory to maintain itself in position covering the dental curing light.

The sleeve may have additional features, for instance, a ring section located at the open proximal end. The ring section may have a grip, which is also heat sealed to at least one of the sheets of impermeable polymeric material. Additionally, the ring section may have a section of at least one of the sheets of polymeric material that extends beyond the grip. The grip will be opposite the section that extends beyond the grip. The sleeve can be configured such that it lies flat until affixed to the dental curing light. Also, it is preferred that the sleeve fits snugly over the dental curing light, which maximizes the amount of light output from the dental curing light.

Another primary object of the present invention is to provide a sleeve with multiple sections of varying circumferences to accommodate a variety of different shaped curing lights. For instance, the sleeve could have a first section with a circumference between 1.972 inches (5.01 cm) and 4.5 inches (11.43 cm). The first section could be of a constant circumference or could taper from a starting circumference between 4.125 inches (10.478 cm) and 4.5 inches (11.43 cm) and ending in a circumference between 2.09 inches (5.309 cm) and 4.126 inches (10.48 cm). A second section extends from the first section with a starting circumference the same as that of the first section. The second section has a circumference of at least 1.58 inches (4.013 cm). The second section may have a constant circumference or it could taper from a starting circumference between 1.972 inches (5.009 cm) and 4.126 inches (10.48 cm) and ending in a circumference between 1.58 inches (4.013 cm) and 2.75 inches (6.985 cm). The third section extends from the second section and has a circumference between 1.4 inches (3.556 cm) and 2.751 inches (6.988 cm). The third section could be of a constant circumference or could taper from a starting circumference of at least 1.58 inches (4.013 cm) and ending in a circumference of at least 1.40 inches (3.556 cm). A fourth section extends from the third section and is rounded and closed.

The sleeve may have additional sections. For instance, the sleeve may have a fifth section extending from the first section opposite the second section. The fifth section could have a starting circumference of the first section and extending to a circumference of at least 3.3 inches (8.382 cm). The sleeve may also have a sixth section extending from the fifth section with a circumference of at least 3.3 inches (8.382 cm).

Again, the sleeve may be made of polyethylene. Regardless of the material, the sleeve should be dimensioned to snugly fit over the curing light. Additionally, the sleeve may lie flat until it is affixed to the tubular device.

Another primary object of the invention is a dental curing light sleeve made by a process. The process begins by selecting a tubular device. The tubular device is then measured. Using the measurements, a two-dimensional outline of the tubular device is created. Next, a wire mold is created based off of the two-dimensional outline. The wire mold is bent and adjusted to correspond with the two-dimensional outline. The wire mold will mimic the tubular device, and thus the wire mold may have a variety of different designs, for instance, a tubular body portion with a tip with various tapered regions. Additionally, the tip could have a smaller radius than the tubular body portion. Next, the wire mold is affixed to a metal plate. A plurality of wire molds could be affixed to the metal plate to produce multiple sleeves simultaneously. The wire mold is then heated and at least two sheets of plastic material are fed below the wire mold. The sheets of plastic are then joined by the wire mold. This creates a heat-sealed edge for a sleeve. As a result, the sleeve has an open end opposite the heat sealed edge. Ultimately, the process results in the creation of a sleeve that is tight-fitting about a dental curing light.

In one aspect of the process of making a dental curing light sleeve, three sheets of plastic material may be fed underneath the wire mold. Two of the sheets of plastic material may be configured to be substantially the same length and dimensions, and the third sheet of plastic material may be configured to be shorter in length than the other two sheets. The three sheets of plastic material can then be joined using the heated wire to create a heat seal. Additionally, a ring section may be joined with the sheets of plastic. The ring section may have a grip and at least one of the sheets of plastic material may extend beyond the grip.

These and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views.

FIG. 1 illustrates an isometric view of a dental curing light sleeve with a curing light;

FIG. 2 illustrates a side elevation view of the dental curing light sleeve of FIG. 1;

FIG. 3 illustrates an isometric view of another embodiment of a dental curing light sleeve;

FIG. 4 illustrates a side elevation view of the dental curing light sleeve of FIG. 3;

FIG. 5 illustrates an isometric view of yet another embodiment of a dental curing light sleeve;

FIG. 6 illustrates a side elevation view of the dental curing light sleeve of FIG. 5;

FIG. 7 illustrates an isometric view of still another embodiment of a dental curing light sleeve;

FIG. 8 illustrates a side elevation view of the dental curing light sleeve of FIG. 7;

FIG. 9 illustrates an isometric view of another embodiment of a dental curing light sleeve;

FIG. 10 illustrates a side elevation view of the dental curing light sleeve of FIG. 9;

FIG. 11 illustrates an isometric view of yet another embodiment of a dental curing light sleeve;

FIG. 12 illustrates a side elevation view of the dental curing light sleeve of FIG. 11;

FIG. 13 illustrates an isometric view of another embodiment of a dental curing light sleeve;

FIG. 14 illustrates a side elevation view of the dental curing light sleeve of FIG. 13;

FIG. 15 illustrates a cross section of a dental curing light sleeve along line 15 from FIG. 1; and

FIG. 16 illustrates a flow chart of the process of making a dental curing light sleeve.

In describing the preferred embodiment of the invention which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the words connected, attached, and terms similar thereto are often used. They are not limited to direct connection but include connection through other elements where such connection is recognized as being equivalent by those skilled in the art.

### DESCRIPTION OF PREFERRED EMBODIMENTS

The present invention and the various features and advantageous details thereof are explained more fully with reference to the non-limiting embodiments described in detail in the following description.

### 1. System Overview

In producing a sleeve, the first consideration is the size of the instrument to which the sleeve will be attached. Each instrument has a number of critical points, specifically, the largest and smallest portions of the instrument. Additional critical points may be located on the instrument, such as buttons or other protrusions. Obviously, these portions are the most important in designing a sleeve that will fit tightly but will not break. In practice, measurements of the length of the instrument are taken starting at the tip and working back to the largest part. One way of completing these measurements is by using a piece of tape. The tape is wrapped around the instrument and marked at a variety of different circumferences. The tape is then laid out on a piece of paper and the circumferences are documented. Additionally, the material of the instrument is also considered, as some materials may cause the sleeve to break more easily than others. An error factor is added to the measurement to provide for abnormalities with material and shape of the instrument. Additionally, sometimes the handle will also need to be covered, not just the instrument.

Once the layout of the sleeve is complete, a number of test prototypes are created. The sample prototypes are used on the instrument to test usability. Additionally, the sample prototypes may be used on a number of different instruments. If the sleeve does not fit, or repeatedly breaks, alterations are made to the design. Through a trial and error process, the design can be completed. Obviously, the challenge is greatest when an instrument has a number of different curves, bends, or other protrusions. The ultimate goal is to create a sleeve that is tight fitting. Especially for instruments like curing lights, the tight fit of the sleeve is critically important as it helps to ensure maximum curing exposure. For similar reasons, a tight fitting sleeve helps ensure a clear image with a dental camera. Additionally, a tight fitting sleeve is beneficial for any instrument as this will minimize the impact of the sleeve on the user's ability to efficiently perform procedures.

### 2. Detailed Description of Preferred Embodiments

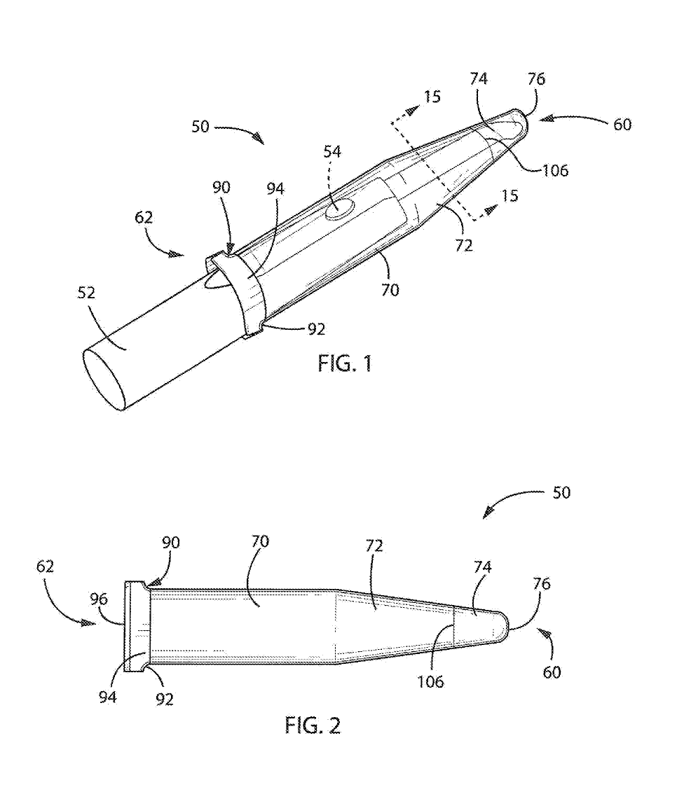

Referring initially to FIGS. 1-14, a number of curing light sleeves 50 are disclosed. The sleeves 50 are configured such that they form a tight fitting, snug connection with a variety of different curing lights 52. Each sleeve 50 may be made of a polymeric material, preferably polyethylene. Polyethylene provides several advantages for this type of use. First, polyethylene is relatively inexpensive, which is important as the sleeves 50 are only used once before disposal. Additionally, polyethylene has sufficient elastic material memory to maintain itself in position covering the dental curing light 52. Also, polyethylene has enough elasticity to allow the sleeve 50 to stretch without breaking.

Each sleeve 50 has a closed distal end 60, an open proximal end 62, and a tubular structure which will have at least four sections 70, 72, 74, and 76. Other embodiments of the sleeve 50 may have additional sections. The sections of the tubular structure will have varying circumferences that are selected to accommodate varying sizes of dental curing lights 52. Depending on the design of the dental curing light 52, the sections of the sleeve 50 will have a combination of regions of tapered circumferences and regions of constant circumference. The tubular structure may have numerous configurations such that it will be shaped to accept curing lights of varying sizes and shapes.

In addition to the sections of the tubular structure, the open proximal end 62 may have a ring section 90 that extends away from the closed distal end 60. The ring section 90 begins with a circumference equal to the circumference at the end of the tubular section, and extends to a greater circumference that will better facilitate insertion of a curing light 52. Preferably, the ring section 90 will have a grip 94 that is made of a heavier plastic material than the remaining portions of the sleeve 50. This heavier plastic material can still stretch, but provides more rigidity than the remaining portions of the sleeve 50. Unlike the other parts of the sleeve 50, the material of grip 94 of the ring section 90 is not transparent and thus is easy for a user to identify when trying to open the sleeve 50 for insertion of the curing light 52. This allows the user to easily grip the ring section 90 and open the proximal end 62 of the sleeve 50. Additionally, the ring section 90 has an upper portion 96 of the sleeve 50 opposite the grip 94 that extends beyond the length of the grip 94. The upper portion 96 of the sleeve 50 can also be gripped. This allows a user to insert the curing light 52 into the ring section 90 between the grip 94 and the upper portion 96 of the sleeve 50.

In practice, the curing light 52 will first be inserted into the ring section 90 and then further inserted into the tubular structure of the sleeve 50. Each sleeve has an inner surface 64 configured to surround a volume and accept a curing light 52. This reduces cross-contamination and the spread of disease, which may occur if the curing light 52 is reused without disinfection. This will be especially useful when the curing light 52 is used on multiple patients in a short duration.

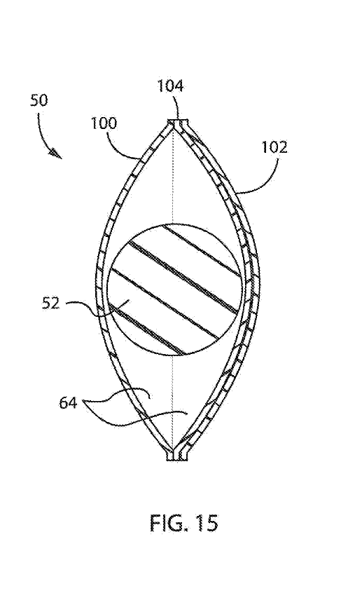

Each sleeve 50 is made of at least two sheets of polymeric material, and preferably three sheets of the polymeric material 100, 102, 104, that are joined. Additionally, the grip 94 of the ring section 90 may also be joined with the three sheets of polymeric material 100, 102, 104. In practice, the three sheets of polymeric material 100, 102, 104 and the grip section 94 of the ring section 90 are laid down, and then heat sealed together. The three sheets 100, 102, 104 can best be viewed in FIG. 15, which shows a cross section of a dental curing light sleeve 50 along line 15 of FIG. 1. FIG. 15 shows the relationship between the three sheets 100, 102, 104, and also shows the inner surface 64 in contact with a dental curing light 52. Preferably, the third sheet 104 is laid between the first 100 and second 102 sheets of polymeric material. As shown, the first sheet 100 and second sheet 102 are of generally the same dimensions. The third sheet 104 is shorter, as can be seen by the end 106 of the third sheet 104, which does not extend to the closed distal end 60. In one embodiment, the third sheet 104 is made of a different material that is more slippery. For instance, a sheet of ethyl methyl acrelate copolymer may be used. This allows the curing light 52 to more easily slide into the sleeve 50. Similarly, first sheet 100 located opposite the third sheet 104 may be made of a similar material to further accommodate the curing light 52. In a preferred embodiment, the second sheet 102 is made of the high clarity polyethylene. However, all of the three sheets 100, 102, 104 could be made of either material. Other materials may be used for any of the three sheets 100, 102, 104 to provide different properties.

In an alternative embodiment, the third sheet 104 extends through the bulk of the body of the sleeve 50 to provide added strength but does not extend to the distal end 60, which could result in an obstruction of the dental curing light 52. A more transparent window is created when only two sheets of polymeric material 100, 102 are heat sealed at the distal end 60 rather than three. As would be appreciated by one skilled in the art, the third sheet 104 is dimensioned to fulfill the required strength of the sleeve 50 in comparison to the curing light 52. For instance, if the curing light 52 has many buttons or protrusions, or is made of a material that easily sticks to the sleeve 50 and thus causes easy rupture of the sleeve, the third sheet 104 will be longer. Conversely, if the curing light 52 can easily be slid into the sleeve 50, the need for a long third sheet 104 will likely be unnecessary. As such, the third sheet 104 may have a number of different designs to accommodate a number of different curing lights 52. Another added benefit to having a shorter third sheet 104 of polymeric material is that a stronger sleeve 50 is created while keeping production costs down.

Moving now to FIGS. 1 and 2, a first embodiment of the dental curing light sleeve 50 is disclosed. FIG. 1 provides an exemplary curing light 52 being used with the sleeve 50. As can be seen, this sleeve 50 has four sections. The first section 70 has a constant circumference of 3.75 inches (9.525 cm). The first section 70 has a length of approximately 4.6245 inches (11.7462 cm). The second section 72 extends from the first section 70 for a length of approximately 3.938 inches (10.01 cm). Because the second section 72 extends from the first section 70, the second section 72 has a starting circumference of 3.75 inches (9.525 cm). The second section 72 tapers down from the starting circumference to an ending circumference of 1.58 inches (4.013 cm). The third section 74 extends from the second section 72 for a length of approximately 0.072 inches (0.183 cm). The third section 74 has a starting circumference equal to the ending circumference of the second section 72, 1.58 inches (4.013 cm). The third section 74 tapers down to an ending circumference of 1.56 inches (3.962 cm). Finally, the fourth section 76 extends from the third section 74. The fourth section 76 starts at a circumference of 1.56 inches (3.962 cm) and tapers to a closed tip that is rounded. The first section 70 may extend in the direction opposite the second section 72 to a ring section 90 that accepts the curing light 52. The ring section 90 begins at a circumference of 3.75 inches (9.525 cm) then expands to a wider circumference by a taper. The taper may be a straight line, or it may taper by a curve 92 at a specified radius, as illustrated at a radius of 0.1875 inches (0.4763 cm). As a result, the edge of the ring 90 has a wider circumference. The ring section 90 may have a grip 94 and an upper portion 96 of the sleeve 50 opposite the grip 94. In a preferred embodiment, the upper portion 96 of the sleeve 50 will extend further than the grip 94.

As discussed above, the sleeve 50 may be made of three sheets of polymeric material 100, 102, 104. The three sheets 100, 102, 104 and the ring section 90 may be joined together, for instance, by a heat seal. The third sheet 104 does not extend to the distal end 60 of the sleeve 50. More specifically, the third sheet extends from the edge of the upper portion 96 of the ring section 90, through all of the first section 70, and into part of the second section 72, for a total length of approximately 7.5 inches (19.05 cm). As a result, the curing light 52 will be minimally obstructed and a more transparent window will be created.

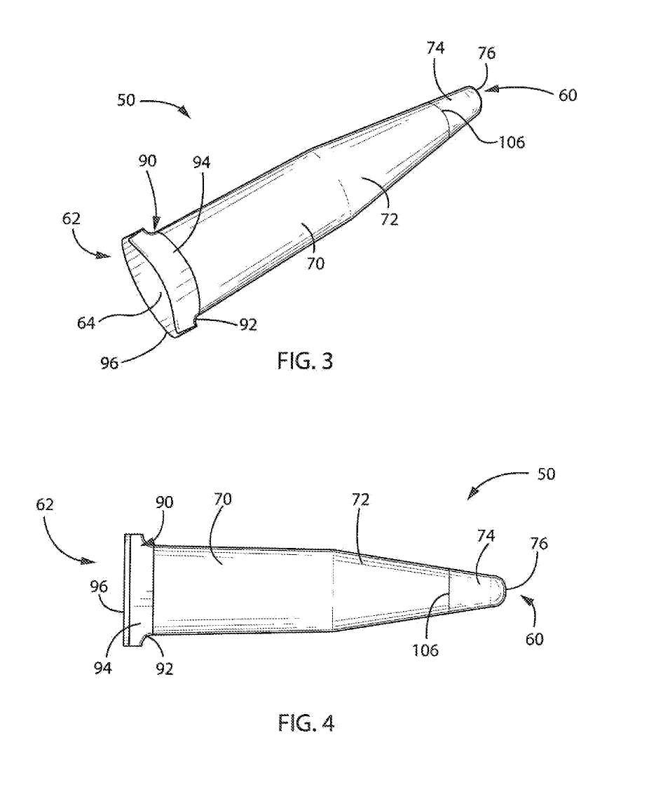

Turning next to FIGS. 3 and 4, an alternative embodiment of the dental curing light sleeve 50 is disclosed. Again, this embodiment of the sleeve 50 has four sections. The first section 70 has a starting circumference of 4.5 inches (11.43 cm). The first section 70 tapers from the starting circumference to an ending circumference of 4.126 inches (10.48 cm) over a length of approximately 4.53075 inches (11.5081 cm). The second section 72 extends from the first section 70 for a length of approximately 3.938 inches (10.01 cm). The second section 72 has a starting circumference equal to the ending circumference of the first section 70, 4.126 inches (10.48 cm). The second section 72 also tapers from the starting circumference to an ending circumference of 1.58 inches (4.013 cm). The third section 74 extends from the second section 72 for a length of approximately 0.072 inches (0.183 cm). The third section has a starting circumference equal to the ending circumference of the second section 72, 1.58 inches (4.013 cm). The third section tapers down from the starting circumference to an ending circumference of 1.56 inches (3.962 cm). Finally, the fourth section 76 extends from the third section 74. The fourth section 76 starts at a circumference of 1.56 inches (3.962 cm) and tapers to a closed tip that is rounded.

The first section 70 may extend opposite the direction of the second section 72 to a ring section 90 that accepts the curing light 52. The ring section 90 begins with a circumference equal to the circumference at the beginning of the first section 70, 4.5 inches (11.43 cm). The ring section 90 then expands to a wider circumference by a taper. The taper may be a straight line, or it may taper by a curve 92 at a specified radius, as illustrated at a radius of 0.28125 inches (0.71438 cm). As a result of the curve 92 of the ring section 90, the end circumference of the ring section is approximately 5.625 inches (14.2875 cm). The ring section 90 extends at a constant circumference of approximately 5.625 inches (14.2875 cm) for approximately 0.5 inches (1.27 cm). The ring section 90 may include a grip 94 and an upper portion 96 of the sleeve 50 located opposite the grip 94. The upper portion 96 may extend beyond the grip 94.

As discussed above, the sleeve 50 may be made of three sheets of polymeric material 100, 102, 104. The three sheets 100, 102, 104 and the ring section 90 may be joined together, for instance, by a heat seal. The third sheet 104 does not extend to the distal end 60 of the sleeve 50. More specifically, the third sheet extends from the edge of the upper portion 96 of the ring section 90, through all of the first section 70, and into part of the second section 72, for a total length of approximately 7.5 inches (19.05 cm). As a result, the curing light 52 will be minimally obstructed and a more transparent window will be created.

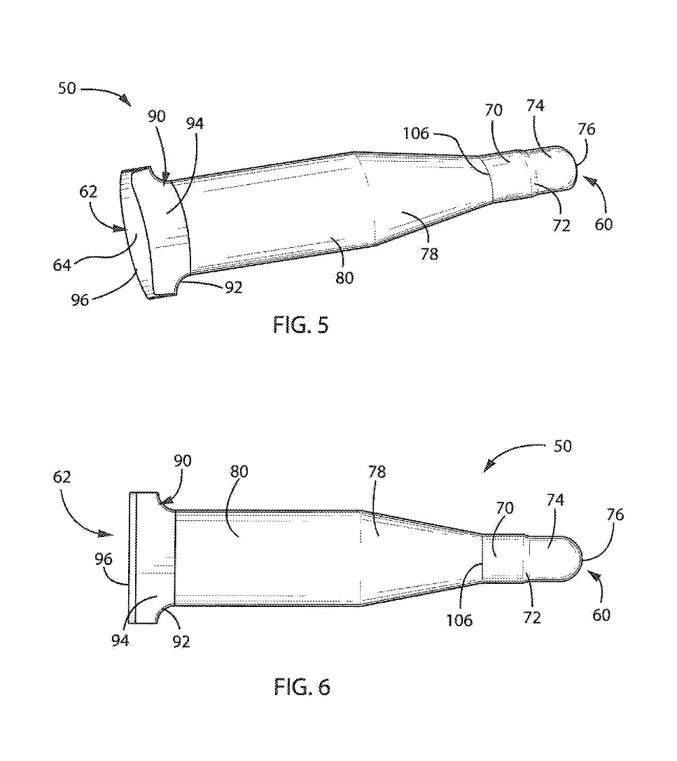

Looking to FIGS. 5 and 6, another embodiment of the dental curing light sleeve is disclosed. In this embodiment, the sleeve 50 has six sections. The first section 70 has a constant circumference of 2.09 inches (5.309 cm) and a length of approximately 0.87 inches (2.21 cm). The second section 72 extends from the first section 70, and thus has a starting circumference equal to that of the first section 70. The second section 72 tapers from the starting circumference to an ending circumference of 1.94 inches (4.928 cm) for a length of approximately 0.13 inches (0.33 cm). The third section 74 extends from the second section, and has a constant circumference equal to the ending circumference of the second section 72, 1.94 inches (4.928 cm). The third section 74 has a length of approximately 0.64 inches (1.625 cm). The fourth section 76 extends from the third section 74. The fourth section 76 is rounded and closed and has a diameter of 0.97 inches (2.464 cm). The fifth section 78 extends from the first section 70 in the opposite direction of the second section 72. Thus, the fifth section 78 begins with the same circumference as the first section 70 but tapers outwardly to a circumference of 4.125 inches (10.478 cm) for a length of approximately 2.625 inches (6.668 cm). The sixth section 80 extends from the fifth section 78 for a length of approximately 3.875 inches (9.8425 cm), with a constant circumference equal to the final circumference of the fifth section 78, 4.125 inches (10.478 cm).

The sixth section 80 may extend opposite the direction of the fifth section 78 to a ring section 90 that accepts the curing light 52. The ring section 90 begins with a circumference equal to the final circumference of the sixth section 80, 4.125 inches (10.478 cm). The ring section 90 then expands to a wider circumference by a taper. The taper may be a straight line, or it may taper by a curve 92 at a specified radius, as illustrated at a radius of 0.375 inches (0.953 cm). As a result of the curve 92 of the ring section 90, the end circumference of the ring section is approximately 5.625 inches (14.2875 cm). The ring section 90 has a grip 94 and an upper portion 96 of the sleeve 50 opposite the grip 94. The grip 94 extends at a constant circumference of approximately 5.625 inches (14.2875 cm) for approximately 0.5 inches (1.27 cm). The upper portion 96 of the sleeve 50 extends at a constant circumference of approximately 5.56 inches (14.122 cm) for approximately 0.50 inches (1.27 cm).

As discussed above, the sleeve 50 may be made of three sheets of polymeric material 100, 102, 104. The three sheets 100, 102, 104 and the ring section 90 may be joined together, for instance, by a heat seal. The third sheet 104 does not extend to the distal end 60 of the sleeve 50. More specifically, the third sheet extends from the edge of the upper section 96 of the ring section 90 through all of the sixth section 80 and all of the fifth section 78, for a total length of approximately 7.5 inches (19.05 cm). This allows the first section 70, the second section 72, the third section 74, and the fourth section 76 to only have two sheets 100, 102 of polymeric material. As a result, the curing light 52 will be minimally obstructed and a more transparent window will be created.

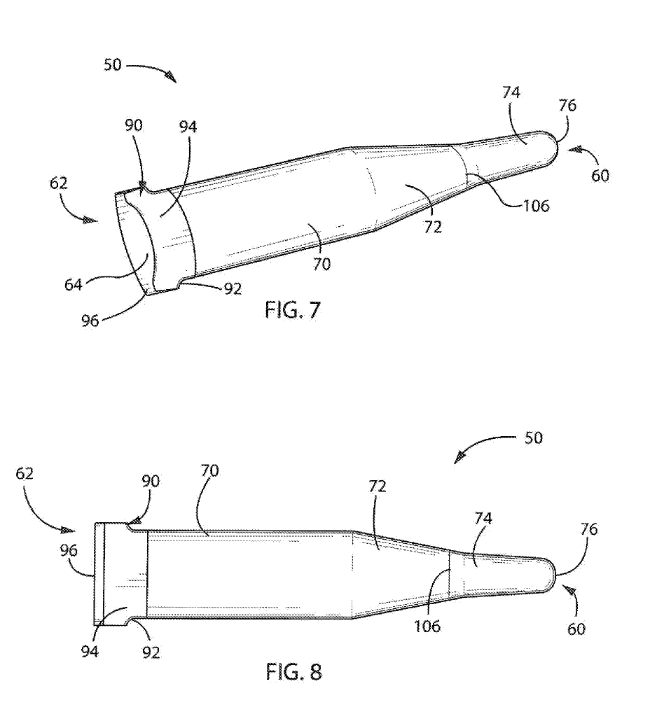

Moving to FIGS. 7 and 8, another embodiment of the dental curing light sleeve 50 is disclosed. In this embodiment, the sleeve 50 has four sections. The first section 70 of the sleeve 50 has a constant circumference of 3.75 inches (9.525 cm) and a length of approximately 4.6245 inches (11.7462 cm). The second section 72 extends from the first section 70 and thus has a starting circumference of 3.75 inches (9.525 cm). The second section 72 tapers down from the starting circumference to an ending circumference of 1.876 inches (4.765 cm) for a length of approximately 2.375 inches (6.033 cm). The third section 74 extends from the second section 72 and therefore has a starting circumference of 1.876 inches (4.765 cm). The third section 74 tapers down from the starting circumference to an ending circumference of 1.476 inches (3.749 cm) for a length of approximately 1.633 inches (4.148 cm). Finally, the fourth section 76 extends from the third section 74. The fourth section begins with a circumference of 1.633 inches (4.148 cm) and tapers to a closed tip that is rounded.

The first section 70 may extend opposite the direction of the second section 72 to a ring section 90 that accepts the curing light 52. The ring section 90 begins with a circumference equal to the starting circumference of the first section, 3.75 inches (9.525 cm). The ring section 90 then expands to a wider circumference by a taper. The taper may be a straight line, or it may taper by a curve 92 at a specified radius, as illustrated at a radius of 0.1875 inches (0.4763 cm). As a result of the curve 92 of the ring section 90, the end circumference of the ring section is approximately 4.5 inches (11.43 cm). The ring section 90 has a grip 94 and an upper portion 96 of the sleeve 50 opposite the grip 94. The grip 94 extends at a constant circumference of approximately 4.5 inches (11.43 cm) for approximately 0.5 inches (1.27 cm). The upper portion 96 of the sleeve 50 extends at a constant circumference of approximately 4.5 inches (11.43 cm) for approximately 0.60 inches (1.524 cm).

As discussed above, the sleeve 50 may be made of three sheets of polymeric material 100, 102, 104. The three sheets 100, 102, 104 and the ring section 90 may be joined together, for instance, by a heat seal. The third sheet 104 does not extend to the distal end 60 of the sleeve 50. More specifically, the third sheet extends from the edge of the upper portion 96 of the ring section 90, through all of the first section 70 and the majority of the second section 72, for a total length of approximately 7.5 inches (19.05 cm). This allows the third section 74 and the fourth section 76 to only have two sheets 100, 102 of polymeric material. As a result, the curing light 52 will be minimally obstructed and a more transparent window will be created.

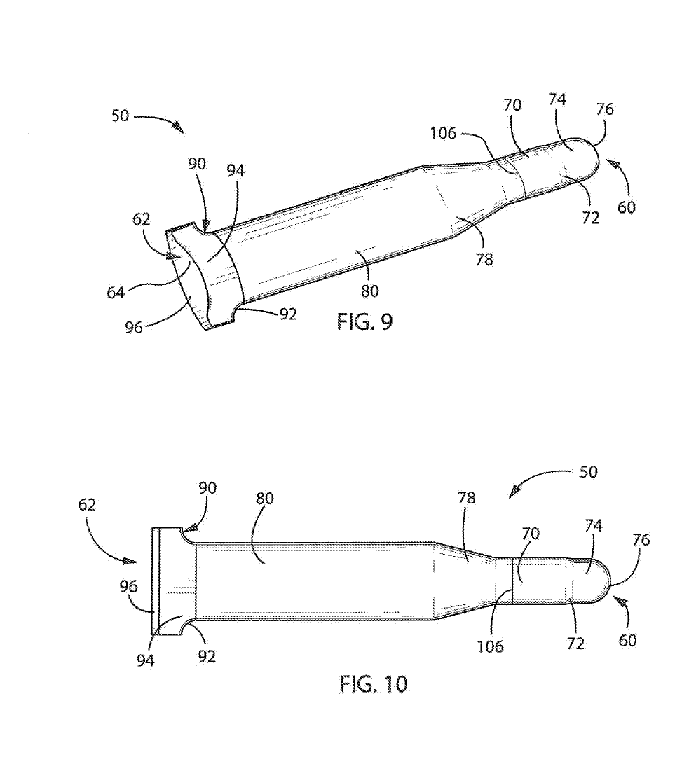

Looking next to FIGS. 9 and 10, an alternate embodiment of the dental curing light sleeve 50 is disclosed. In this embodiment, the sleeve 50 has six sections. The first section 70 of the sleeve 50 has a constant circumference of 1.972 inches (5.009 cm) and a length of approximately 1.496 inches (3.800 cm). The second section 72 extends from the first section 70 and thus has the same starting circumference, 1.972 inches (5.009 cm). The second section 72 then tapers from the starting circumference to the ending circumference of 1.88 inches (4.775 cm). The second section 72 has a length of approximately 0.129 inches (0.328 cm). The third section 74 extends from the second section and has a constant circumference of 1.88 inches (4.775 cm) and a length of approximately 0.346 inches (0.879 cm). The fourth section 76 extends from the third section 74 and is rounded and closed. The circumference of the fourth section 76 is 0.94 inches (2.388 cm). The fifth section 78 extends from the first section 70 in the opposite direction as the second section 72 for a length of approximately 1.309 inches (3.325 cm). Therefore, the fifth section 78 begins with a circumference of 1.972 inches (5.009 cm). The fifth section 78 then tapers outwardly to circumference of 3.3 inches (8.382 cm). The sixth section 80 extends from the fifth section 78 at a constant circumference of 3.3 inches (8.382 cm) for a length of approximately 5.075 inches (12.8905 cm).

The sixth section 80 may extend opposite the direction of the fifth section 78 to a ring section 90 that accepts the curing light 52. The ring section 90 begins with a circumference equal to the circumference of the sixth section 80, 3.3 inches (8.382 cm). The ring section 90 then expands to a wider circumference by a taper. The taper may be a straight line or it may taper by a curve 92 at a specified radius, as illustrated at a radius of 0.3 inches (0.762 cm). As a result of the curve 92 of the ring section 90, the end circumference of the ring section is approximately 4.5 inches (11.43 cm). The ring section 90 has a grip 94 and an upper portion 96 of the sleeve 50 opposite the grip 94. The grip 94 extends at a constant circumference of approximately 4.5 inches (11.43 cm) for approximately 0.5 inches (1.27 cm). The upper portion 96 of the sleeve 50 extends at a constant circumference of approximately 4.5 inches (11.43 cm) for approximately 0.625 inches (1.5875 cm).

As discussed above, the sleeve 50 may be made of three sheets of polymeric material 100, 102, 104. The three sheets 100, 102, 104 and the ring section 90 may be joined together, for instance, by a heat seal. The third sheet 104 does not extend to the distal end 60 of the sleeve 50. More specifically, the third sheet extends from the edge of the upper portion 96 of the ring section 90 through all of the sixth section 80, all of the fifth section 78, and part of the first section 70 for a total length of approximately 7.5 inches (19.05 cm). This allows the remainder of the first section 70, the second section 72, the third section 74, and the fourth section 76 to only have two sheets 100, 102 of polymeric material. As a result, the curing light 52 will be minimally obstructed and a more transparent window will be created.

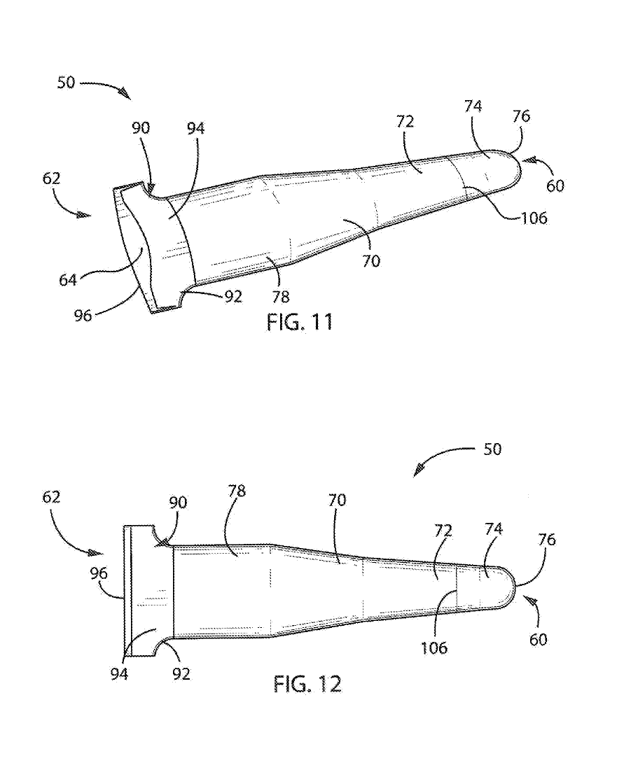

Turning to FIGS. 11 and 12, another embodiment of the dental curing light sleeve 50 is illustrated. This embodiment of the sleeve 50 has five sections. The first section 70 has a starting circumference of 4.0 inches (10.16 cm). The first section 70 tapers from the starting circumference to a circumference of 2.75 inches (6.985 cm). The length of the first section 70 is approximately 2.0 inches (5.08 cm). The second section 72 extends from the first section 70 for a length of approximately 2.562 inches (6.507 cm). Because the second section 72 extends from the first section 70, the starting circumference of the second section 72 is 2.75 inches (6.985 cm). The second section 72 further tapers from the starting circumference to an end circumference of 1.88 inches (4.775 cm). A third section 74 extends from the second section, and thus has a beginning circumference of 1.88 inches (4.775 cm). The third section tapers to a circumference of 1.814 inches (4.60756 cm). Finally, the fourth section 76 extends from the third section 74. The fourth section begins with a circumference of 1.814 inches (4.608 cm) and tapers to a closed tip that is rounded. The fifth section 78 extends from the first section 70 in the direction opposite the second section 72, and has a constant circumference of 4.0 inches (10.16 cm). The fifth section 78 has a length of approximately 2.09375 inches (3.3181 cm).

The fifth section 78 may extend opposite the direction of the first section 70 to a ring section 90 that accepts the curing light 52. The ring section 90 begins with a circumference equal to the starting circumference of the first section, 4.0 inches (10.16 cm). The ring section 90 then expands to a wider circumference by a taper. The taper may be a straight line, or it may taper by a curve 92 at a specified radius, as illustrated at a radius of 0.40625 inches (1.03188 cm). As a result of the curve 92 of the ring section 90, the end circumference of the ring section is approximately 5.625 inches (14.2875 cm). The ring section 90 has a grip 94 and an upper portion 96 of the sleeve 50 opposite the grip 94. The grip 94 extends at a constant circumference of approximately 5.625 inches (14.2875 cm) for approximately 0.5 inches (1.27 cm). The upper portion 96 of the sleeve 50 extends at a constant circumference of approximately 5.5 inches (13.97 cm) for approximately 0.625 inches (1.5875 cm).

As discussed above, the sleeve 50 may be made of three sheets of polymeric material 100, 102, 104. The three sheets 100, 102, 104 and the ring section 90 may be joined together, for instance, by a heat seal. The third sheet 104 does not extend to the distal end 60 of the sleeve 50. More specifically, the third sheet extends from the edge of the upper portion 96 of the ring section 90, through all of the fifth 78, the first 70 and second 72 sections for a total length of approximately 7.5 inches (19.05 cm). This allows the third section 74 and the fourth section 76 to only have two sheets 100, 102 of polymeric material. As a result, the curing light 52 will be minimally obstructed and a more transparent window will be created.

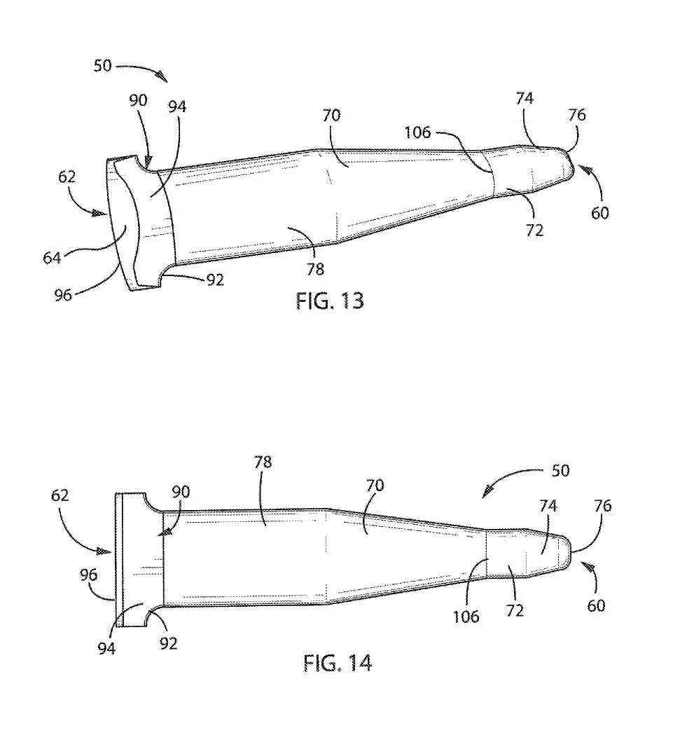

Looking now to FIGS. 13 and 14, an alternative embodiment of the dental curing light sleeve 50 is shown. In this embodiment of the sleeve 50, there are five sections. The first section 70 has a starting circumference of 4.125 inches (10.478 cm). The first section 70 tapers from the starting circumference to a final circumference of 2.09 inches (5.309 cm). The total length of the first section 70 is approximately 3.437 inches (8.730 cm). The second section 72 extends from the first section 70 and has a constant circumference of 2.09 inches (5.309 cm) and a length of approximately 0.86 inches (2.184 cm). The third section 74 extends from the second section 72 and thus has a starting circumference of 2.09 inches (5.309 cm). The third section 74 tapers down from the starting circumference to an end circumference of 1.48 inches (3.759 cm). The total length of the third section is approximately 0.703 inches (1.786 cm). The fourth section 76 extends from the third section, and starts at a circumference of 1.48 inches (3.759 cm) and tapers to a closed tip that is rounded. The fifth section 78 extends from the first section 70 opposite the direction of the second section 72 for a length of approximately 3.5 inches (8.89 cm). The fifth section 78 has a constant circumference of 4.125 inches (10.478 cm). The fifth section 78 may extend in the direction opposite the first section 70 to a ring section 90 that accepts the curing light 52. The ring section 90 begins at a circumference of 4.125 inches (10.478 cm), and then expands to a wider circumference by a taper. The taper may be a straight line or it may taper by a curve 92 at a specified radius, as illustrated at a radius of 0.375 inches (0.953 cm). As a result, the edge of the ring 90 has a wider circumference. The ring section 90 may have a grip 94 and an upper portion 96 of the sleeve 50 opposite the grip 94. In a preferred embodiment, the upper portion 96 of the sleeve 50 will extend further than the grip 94.

The above-described embodiments of the curing light sleeve 50 provide several non-limiting examples that illustrate some of the possible configurations of dental curing light sleeves 50. As will be appreciated, the sleeves 50 need not be in the precisely defined dimensions, but rather may vary slightly to better accommodate a given curing light 52. For instance, the size of the sleeve 50 may be adjusted due to the material of the curing light 52. Some curing lights 52 are made of materials that easily catch on the sleeve 50. As a result, a sleeve 50 for use with these curing lights 52 may have a greater built-in tolerance to accommodate these curing lights 52. Other curing lights 52 slide into a sleeve 50 very easily. The dimensions for a sleeve associated with this type of curing light 52 will be more tightly defined to reflect the size of the curing light 52. Additionally, other features of curing lights 52 must be considered when dimensioning the sleeve 50. For instance, some curing lights 52 have buttons 54 or other protrusions that may get caught on the sleeve 50. As a result, sleeves 50 designed for those types of curing lights 52 will have additional built-in tolerance to facilitate these types of protrusions.

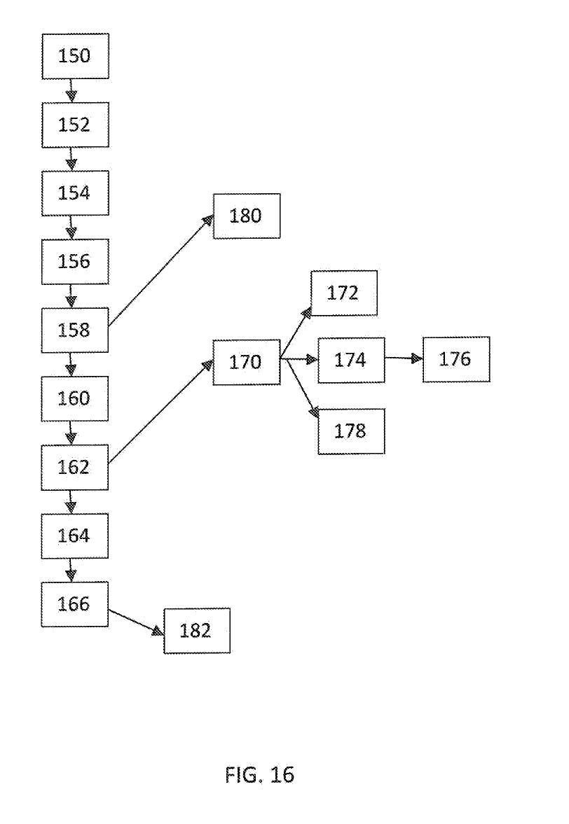

Moving now to FIG. 16, a dental curing light sleeve is made by a process. First, a tubular device is selected 150. The tubular device is then measured 152. From the measurement, a two-dimensional outline of the tubular device is created 154. This outline is then used to create a wire mold that is bent to the shape of the tubular device 156. Once the wire mold is bent, it is connected to a metal plate 158. Multiple wire molds may be connected to the metal plate, which allows multiple sleeves to be manufactured with each pressing 180. The mold is then heated 160. Next, at least two sheets of plastic material are fed underneath the wire mold 162. In one embodiment, three sheets of plastic material may be fed underneath the wire mold, where two of the sheets of plastic material are substantially the same length and dimensions, and the third sheet is configured to be a shorter length 170. When the three sheets are pressed together, the two sheets that extend to the distal end of the sleeve will result in a more transparent window 178. The sheets of plastic material are then pressed against the metal plate with at least one wire mold 164. Finally, the sheets of plastic material are joined into a sleeve by the heated wire 166. Additionally, a ring section located on one end of the sheets of plastic material may also be joined by the heated wire 174. At least one of the sheets of plastic material may extend beyond a grip in the ring section 176. The sleeve is created to be tight-fitting about the dental curing light 182.

It will be appreciated by one skilled in the art that the steps of the process of making a dental curing sleeve may happen in any number of different orders. Additional steps may be added to the process as well. Dental curing sleeves may also be made without performing each of the disclosed steps.

Although the best mode contemplated by the inventors of carrying out the present invention is disclosed above, practice of the present invention is not limited thereto. It will be manifest that various additions, modifications and rearrangements of the features of the present invention may be made without deviating from the spirit and scope of the underlying inventive concept.

For example, the sleeve could be enhanced by providing additional features that would make the sleeve easier to use. For instance, the sleeve may be lined with a material that would make it easier for the sleeve to slide onto a dental curing light. Similarly, although polyethylene is the preferred material for the sleeve, any material could be used in its place. In addition, the individual components need not be fabricated from the disclosed materials, but could be fabricated from virtually any suitable materials.

Moreover, the individual components need not be formed in the disclosed shapes, or assembled in the disclosed configuration, but could be provided in virtually any shape, and assembled in virtually any configuration, so as to provide a tight-fitting sleeve. For instance, different sized sleeves could be used to better conform to different curing lights. Furthermore, all the disclosed features of each disclosed embodiment can be combined with, or substituted for, the disclosed features of every other disclosed embodiment except where such features are mutually exclusive.

It is intended that the appended claims cover all such additions, modifications and rearrangements. Expedient embodiments of the present invention are differentiated by the appended claims.

What is claimed is:

1. A single use sleeve formed by heat sealing at least two sheets of an impermeable polymeric material, the sleeve having a distal end, an open proximal end, and an inner surface substantially surrounding a volume adapted for placement over a dental curing light for preventing cross-contamination and spread of diseases which may be transmitted by or through contact with human body fluids and tissues during a first and subsequent use of the dental curing light in conjunction with the treatment of two or more patients eliminating the need for repeated disinfection of the dental curing light between such uses for two or more patients, comprising an elongated tubular sleeve with at least four sections of varying circumferences and one end section that is rounded and closed at the distal end, the first of the at least four sections having a circumference of approximately 4.0 inches (10.16 cm) and tapering to a circumference of approximately 2.75 inches (6.985 cm), the second of the at least four sections beginning with a circumference of approximately 2.75 inches (6.985 cm) and tapering to a circumference of approximately 1.88 inches (4.775 cm), the third of the at least four sections beginning with a circumference of approximately 1.88 inches (4.775 cm) and tapering to a circumference of approximately 1.814 inches (4.608 cm), and the fourth of the at least four sections having a constant circumference of approximately 4.0 inches (10.16 cm) and wherein the sleeve maintains itself in the position covering the dental curing light without slippage until manual removal.

2. The sleeve of claim 1 further comprising a ring section located at the proximal end.

3. The sleeve of claim 2, wherein the ring section comprises:
a grip heat sealed to at least one of the sheets of impermeable polymeric material; and
a section of at least one of the sheets of polymeric material that extends beyond the grip, wherein the section of the at least one of the sheets of polymeric material is located opposite the grip.

4. The sleeve of claim 1, wherein the impermeable polymeric material is polyethylene.

5. The sleeve of claim 1, wherein the sleeve fits snugly over the dental curing light.

6. A curing light sleeve comprising:
a) a first section having a circumference between 1.972 inches (5.01 cm) and 4.5 inches (11.43 cm);
b) a second section having a circumference starting at the circumference of the first section and ending with a circumference of at least 1.58 inches (4.013 cm);
c) a third section extending from the second section and having a circumference between 1.4 inches (3.556 cm) and 2.751 inches (6.988 cm); and
d) a fourth section extending from the third section that is rounded and closed.

7. The sleeve of claim 6, wherein the first section may taper from a starting circumference between 4.125 inches (10.478 cm) and 4.5 inches (11.43 cm) and ending in a circumference between 2.09 inches (5.309 cm) and 4.126 inches (10.48 cm).

8. The sleeve of claim 6, wherein the second section may taper from a starting circumference between 1.972 inches (5.009 cm) and 4.126 inches (10.48 cm) and ending in a circumference between 1.58 inches (4.013 cm) and 2.75 inches (6.985 cm).

9. The sleeve of claim 6, wherein the third section may taper from the starting circumference of at least 1.58 inches (4.013 cm) and ending in a circumference of at least 1.40 inches (3.556 cm).

10. The sleeve of claim 6, further comprising
a fifth section extending from the first section opposite the second section, the fifth section starting at the circumference of the first section and extending to a circumference of at least 3.3 inches (8.382 cm), and
a sixth section extending from the fifth section with a circumference of at least 3.3 inches (8.382 cm).

11. The sleeve of claim 6, wherein the sleeve is made of polyethylene.

12. The method of claim 6, wherein the sleeve fits snugly over a curing light.

13. A dental curing light sleeve made by a process comprising:
a) selecting a tubular device;
b) measuring the tubular device;
c) creating a two-dimensional outline of the tubular device based on the measurement;
d) using the two-dimensional outline of the tubular device to create a wire mold that is bent in the shape of the tubular device;
e) affixing at least one wire mold to a metal plate;
f) supplying heat to the wire mold;
g) feeding at least two sheets of a plastic material underneath the wire mold;
h) pressing the sheets against the metal plate with at least one wire mold; and
i) joining the sheets of plastic into a sleeve with the heated wire.

14. The method of claim 13, further comprising the step of feeding three sheets of plastic underneath the wire mold, where two of the sheets of plastic are configured to be substantially the same length, and the third sheet is configured to be a shorter length.

15. The method of claim 14, further comprising the step of joining the sheets of plastic into a sleeve with the heated wire to create a heat seal.

16. The method of claim 14, further comprising the step of joining the sheets of plastic and a ring section located on one end of the sheets of plastic into a sleeve with the heated wire to create a heat seal.

17. The method of claim 16, further comprising the step of joining the sheets of plastic and the ring section into a sleeve with the heated wire to create a heat seal, wherein at least one of the sheets of plastic extends beyond a grip of the ring section.

18. The method of claim 14, further comprising the steps of
feeding three sheets of plastic underneath the wire mold, where two of the sheets of plastic are configured to be substantially the same length, and the third sheet is configured to be a shorter length, and
creating a more transparent window with only two sheets at a distal end of the sleeve.

19. The method of claim 13, further comprising the step of affixing a plurality of wire molds to the metal plate such that a plurality of sleeves are manufactured with each pressing.

20. The method of claim 13, further comprising the step of creating the sleeve such that it is tight-fitting about a dental curing light.
